(19) United States
(12) Patent Application Publication
(10) Pub. No.: US 2014/0188954 A1
(43) Pub. Date: Jul. 3, 2014

(54) COMPUTING DEVICE AND FILE STORING METHOD

(71) Applicant: HON HAI PRECISION INDUSTRY CO., LTD., New Taipei (TW)

(72) Inventors: KUAN-CHIAO PENG, New Taipei (TW); CHIEN-FA YEH, New Taipei (TW); CHUNG-I LEE, New Taipei (TW); YEN-HUNG LIN, New Taipei (TW)

(73) Assignee: HON HAI PRECISION INDUSTRY CO., LTD., New Taipei (TW)

(21) Appl. No.: 14/035,977

(22) Filed: Sep. 25, 2013

(30) Foreign Application Priority Data
Dec. 27, 2012 (TW) 101150331

(51) Int. Cl. G06F 17/30

(52) U.S. Cl. CPC G06F 17/30194
USPC 707/827

(57) ABSTRACT

In a file storing method executed by a computing device, storage space of a cloud storage device in a network is allocated to multiple client computers. When a client computer stores a file into the storage space allocated to the client computer in the cloud storage device, a webpage of the file including a web address of the file in the network is generated. The web address of the file is encoded to generate a code of the file. The code of the file is transmitted to the client computer.

### BACKGROUND

1. Technical Field

Embodiments of the present disclosure relate to cloud computing technology, and particularly to a computing device and a file storing method of the computing device.

2. Description of Related Art

Cloud storage enables users to access network resources conveniently. A user can upload files to a cloud storage device in a network. When downloading a file from the cloud storage device or sharing the file with other users, the user is required to input a file address of the file in the network. However, the file address of the file can be complex and hard to remember.

### BRIEF DESCRIPTION OF THE DRAWINGS

FIG. 1 is one embodiment of an application of a computing device including a file storage system.

FIG. 2 is a block diagram of one embodiment of function modules of the file storage system in FIG. 1.

FIG. 3 is a flowchart of one embodiment of a file storing method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of computer program instructions, written in a programming language, such as, JAVA, C, or assembly. One or more computer program instructions in the modules may be embedded in firmware, such as in an erasable programmable read only memory (EPROM). The modules described herein may be implemented as either computer program and/or hardware modules and may be stored in any type of non-transitory computer-readable medium or other storage device. Some non-limiting examples of non-transitory computer-readable media include CDs, DVDs, BLU-RAY, flash memory, and hard drive drives.

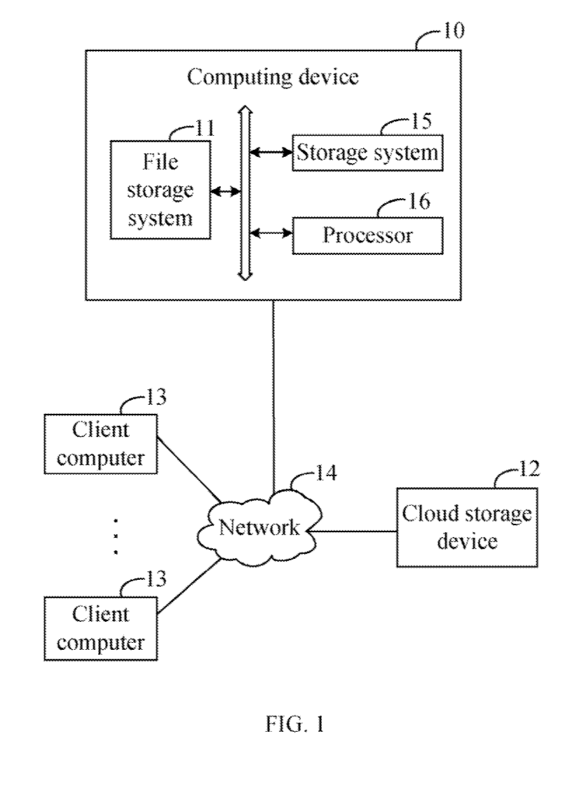

FIG. 1 is one embodiment of an application of a computing device 10 including a file storage system 11. The computing device 10 is connected to a cloud storage device 12 (e.g., a database server) and a plurality of client computers 13 through a network 14. The file storage system 11 allows users to access files stored in the cloud storage device 12 and share the files among the client computers 13 conveniently. The network 14 can be a public network or a private network.

In one embodiment, the computing device 10 further includes a storage system 15 and at least one processor 16. The storage system 15 can be a dedicated memory, such as an EPROM, a hard disk drive (HDD), or flash memory. The storage system 15 can be an external storage device, such as an external hard drive, a storage card, or a data storage medium.

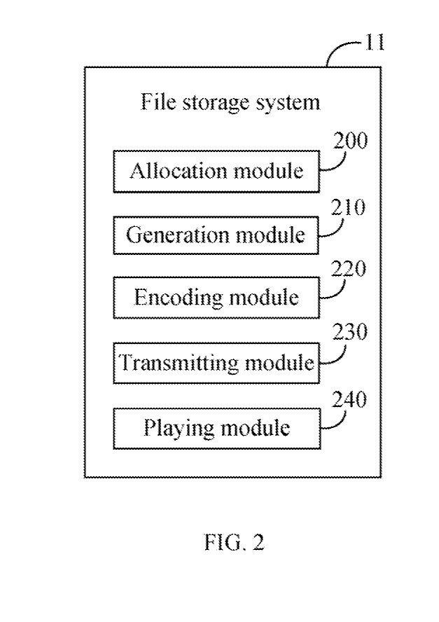

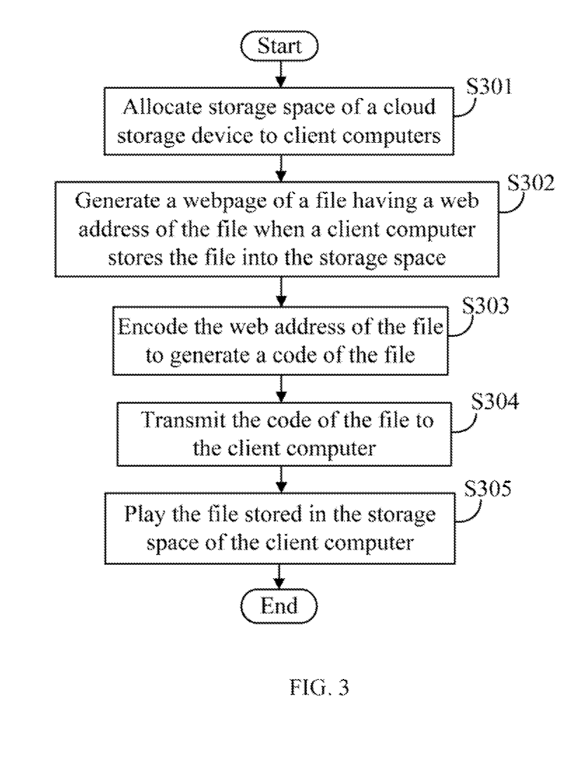

FIG. 2 is a block diagram of one embodiment of function modules of the file storage system 11 in FIG. 1. The file storage system 11 includes an allocation module 200, a generation module 210, an encoding module 220, a transmitting module 230, and a playing module 240. The modules 200-240 may comprise computerized code in the form of one or more programs that are stored in the storage system 15. The computerized code includes instructions that are executed by the at least one processor 16, to provide the aforementioned functions of the file storage system 11. A detailed description of the functions of the modules 200-240 is given in reference to FIG. 3.

FIG. 3 is a flowchart of one embodiment of a file storing method. Depending on the embodiment, additional steps may be added, others removed, and the ordering of the steps may be changed.

In step S301, the allocation module 200 allocates storage space of the cloud storage device 12 to the client computers 13.

In step S302, when a client computer 13 stores a file into the storage space allocated to the client computer 13 in the cloud storage device 12, the generation module 210 generates a webpage of the file. The webpage of the file has a unique web address of the file in the network 14. According to the web address of the file, the webpage of the file is accessible in the network 14. The webpage of the file includes a file type, a file name, a file address, a file size, and file descriptions of the file. The file type may be image, text, audio, or video. The file address is a storage address of the file in the cloud storage device 12. According to the file address, the file is accessible in the network 14. In one embodiment, each of the web address and the file address of the file is a uniform resource locator (URL).

In step S303, the encoding module 220 encodes the web address of the file to generate a code (e.g., two-dimensional barcode) of the file. In one embodiment, the code of the file is a quick response code (QR code).

In step S304, the transmitting module 230 transmits the code of the file to the client computer 13. The client computer 13 receives the code of the file from the computing device 10 and provides the code of the file to other client computers 13. Therefore, other client computers 13 can access the file conveniently. In one example, a client computer denoted as 13A displays the code of the file on a display of the client computer 13A. Another client computer denoted as 13B scans the code of the file using a camera installed in the client computer 13B, decodes the code of the file to obtain the web address of the file, and accesses the webpage of the file according to the web address of the file. In another example, the client computer 13A adds the code of the file to an information media (e.g., a webpage or an email) and sends the information media with the code of the file to the client computer 13B. The client computer 13B receives the information media from the client computer 13A, decodes the code of the file to obtain the web address of the file, and accesses the webpage of the file according to the web address of the file. According to the file address of the file shown in the webpage of the file, the client computer 13B downloads the file from the storage space of the client computer 13A and stores the file in the storage space of the client computer 13B.

In step S305, the playing module 240 receives a file playing request from the client computer 13. In response to the file playing request, the playing module 240 plays the file stored in the storage space of the client computer 13. For example, the playing module 240 plays a video file stored in the storage space of the client computer 13.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A file storing method being executed by a processor of a computing device, the method comprising:
allocating storage space of a cloud storage device to multiple client computers, wherein the cloud storage device is connected to the computing device and the client computers through a network;
in response to a client computer storing a file into the storage space allocated to the client computer in the cloud storage device, generating a webpage of the file, wherein the webpage of the file has a web address of the file in the network;
encoding the web address of the file to generate a code of the file; and
transmitting the code of the file to the client computer.

2. The method of claim 1, further comprising:
receiving a file playing request from the client computer, and playing the file stored in the storage space of the client computer in response to the file playing request.

3. The method of claim 1, wherein the client computer receives the code of the file from the computing device and provides the code of the file to other client computers.

4. The method of claim 1, wherein the webpage of the file comprises a file type, a file name, a file address, a file size, and file descriptions of the file.

5. The method of claim 1, wherein the code of the file is a two-dimensional barcode.

6. A computing device, comprising:
at least one processor; and
a storage system storing a plurality of instructions, when executed by the at least one processor, causing the at least one processor to perform operations comprising:
allocating storage space of a cloud storage device to multiple client computers, wherein the cloud storage device is connected to the computing device and the client computers through a network;
in response to a client computer storing a file into the storage space allocated to the client computer in the cloud storage device, generating a webpage of the file, wherein the webpage of the file has a web address of the file in the network;
encoding the web address of the file to generate a code of the file; and
transmitting the code of the file to the client computer.

7. The computing device of claim 6, wherein the instructions further cause the at least one processor to perform operations comprising:
receiving a file playing request from the client computer, and playing the file stored in the storage space of the client computer in response to the file playing request.

8. The computing device of claim 6, wherein the client computer receives the code of the file from the computing device and provides the code of the file to other client computers.

9. The computing device of claim 6, wherein the webpage of the file comprises a file type, a file name, a file address, a file size, and file descriptions of the file.

10. The computing device of claim 6, wherein the code of the file is a two-dimensional barcode.

11. A non-transitory storage medium storing a set of instructions, the set of instructions capable of being executed by a processor of a computing device to implement a method for storing files, the method comprising:
allocating storage space of a cloud storage device to multiple client computers, wherein the cloud storage device is connected to the computing device and the client computers through a network;
in response to a client computer storing a file into the storage space allocated to the client computer in the cloud storage device, generating a webpage of the file, wherein the webpage of the file has a web address of the file in the network;
encoding the web address of the file to generate a code of the file; and
transmitting the code of the file to the client computer.

12. The non-transitory storage medium of claim 11, wherein the method further comprising:
receiving a file playing request from the client computer, and playing the file stored in the storage space of the client computer in response to the file playing request.

13. The non-transitory storage medium of claim 11, wherein the client computer receives the code of the file from the computing device and provides the code of the file to other client computers.

14. The non-transitory storage medium of claim 11, wherein the webpage of the file comprises a file type, a file name, a file address, a file size, and file descriptions of the file.

15. The non-transitory storage medium of claim 11, wherein the code of the file is a two-dimensional barcode.
